(19) United States
(12) Patent Application Publication
(10) Pub. No.: US 2007/0066148 A1
(43) Pub. Date: Mar. 22, 2007

(54) Connecting terminal

(75) Inventor: Karl Franz Froschl, Hernnbaumgarten (AT)

Correspondence Address: LERNER GREENBERG STEMER LLP, P O BOX 2480, HOLLYWOOD, FL, 33022-2480, US

(73) Assignee: Gebauer & Griller Kabelwerke Gesellschaft m.b.H.

(21) Appl. No.: 11/508,537

(22) Filed: Aug. 23, 2006

(30) Foreign Application Priority Data
Sep. 16, 2005 (AT) 1533/2005

(51) Int. Cl. H01R 13/514

(52) U.S. Cl. 439/752

(57) ABSTRACT

A connecting terminal for connecting an electrical line to an electrical device has a first connection part, which is formed, for example, with an eyelet, and a second connection part, which is in the form of a sleeve. The sleeve is connected to the electrical line by crimping. The second connection part is thereby formed by a sleeve, which is produced from a platelet by way of deformation and whose adjoining edges are provided with opposed projections and cutouts corresponding with the projections. The edges are latched with one another by way of the projections and cutouts.

### BACKGROUND OF THE INVENTION

### FIELD OF THE INVENTION

The invention relates to a connecting terminal for connecting an electrical cable to an electrical engineering device having a first connection part, which is formed, for example, with an eyelet, and having a second connection part, which is in the form of a sleeve and which is connected to the electrical conductor by means of pressing or crimping.

Prior art terminals of the pertinent type for connecting an electrical line to an electrical engineering device comprise a first connection part, which is intended to be connected to an electrical engineering device, and a second connection part, which is used for connecting the terminal to the electrical line. The first connection part is, for example, formed with a connection eyelet. The second connection part is, for example, formed with two tabs, which are bent over the line from which the insulation has been stripped, as a result of which they surround the metallic conductor in the form of a sleeve and are connected to the metallic conductor by means of mechanical deformation.

If, in this case, the terminal is produced from a copper alloy and the conductor is produced from aluminum, owing to the fact that aluminum has a greater coefficient of thermal expansion than a copper alloy, there is, however, the difficulty that expansion of the connection part is caused owing to the thermal expansions of the conductor, as a result of which the electrical conductivity existing between the conductor and the sleeve-shaped connection part is reduced or the contact resistance existing between the terminal and the electrical conductor is increased.

This problem could be avoided by the sleeve-shaped connection part being formed by a closed tube piece. However, since the entire terminal needs to be nickel-plated, it would in this case also be necessary to nickel-plate the tube piece on its inner side, but it is only possible to meet this requirement with a particularly high degree of technical complexity.

### SUMMARY OF THE INVENTION

It is accordingly an object of the invention to provide a connecting terminal, which overcomes the above-mentioned disadvantages of the heretofore-known devices and methods of this general type and wherein the terminal which is nickel-plated on its entire surface and with which it is ensured that the sleeve-shaped connection part surrounding the electrical conductor does not expand owing to thermal expansions of the conductor, as a result of which an increase in the contact resistance existing between the connecting terminal and the electrical conductor is avoided.

With the foregoing and other objects in view there is provided, in accordance with the invention, a connecting terminal for connecting an electrical line to an electrical device, the terminal comprising:
a first connection part formed with connector means;
a second connection part connected to the first connection part and connected or connectible to the electrical line by crimping, i.e., pressing;
the second connection part being a platelet deformed into a sleeve, the sleeve having adjoining edges provided with equal and opposed projections and cutouts corresponding to the projections, with the projections and cutouts latching the adjoining edges with one another.

In other words, the objects are achieved according to the invention by the fact that the second connection part is formed by a sleeve, which is produced from a platelet by means of deformation and whose adjoining edges are provided with diametrically opposed projections or cutouts associated with the projections, by means of which projections and cutouts these edges can be latched with one another.

The mutually opposing edges of the sleeve are preferably formed with at least one undercut projection or with at least one undercut cutout associated with this projection, the at least one projection being inserted into the at least one cutout. The connecting terminal according to the invention is preferably produced from a nickel-plated plate consisting of copper or a copper alloy, in particular consisting of bronze.

In accordance with a preferred method for producing the connection between an electrical conductor and a connecting terminal, the electrical conductor is inserted into the sleeve-shaped second connection part, which is then connected to the electrical conductor by means of pressing.

Other features which are considered as characteristic for the invention are set forth in the appended claims.

Although the invention is illustrated and described herein as embodied in a connecting terminal, it is nevertheless not intended to be limited to the details shown, since various modifications and structural changes may be made therein without departing from the spirit of the invention and within the scope and range of equivalents of the claims.

The construction of the invention, however, together with additional objects and advantages thereof will be best understood from the following description of the specific embodiment when read in connection with the accompanying drawings.

### BRIEF DESCRIPTION OF THE DRAWINGS

FIG. 1 is a plan view onto a platelet which is produced by stamping and from which a connecting terminal according to the invention is manufactured;

FIG. 2 is an axonometric illustration of the platelet after a first processing step;

FIG. 3 is an axonometric illustration of a connecting terminal according to the invention;

FIG. 4 is an axonometric illustration of a connecting terminal according to the invention, into which an electrical conductor is inserted;

FIG. 5 is an axonometric illustration of a connecting terminal according to the invention after it has been connected to the electrical conductor; and

FIG. 6 is plan view onto the assembly of the connecting terminal with the electrical conductor.

### DESCRIPTION OF THE PREFERRED EMBODIMENTS

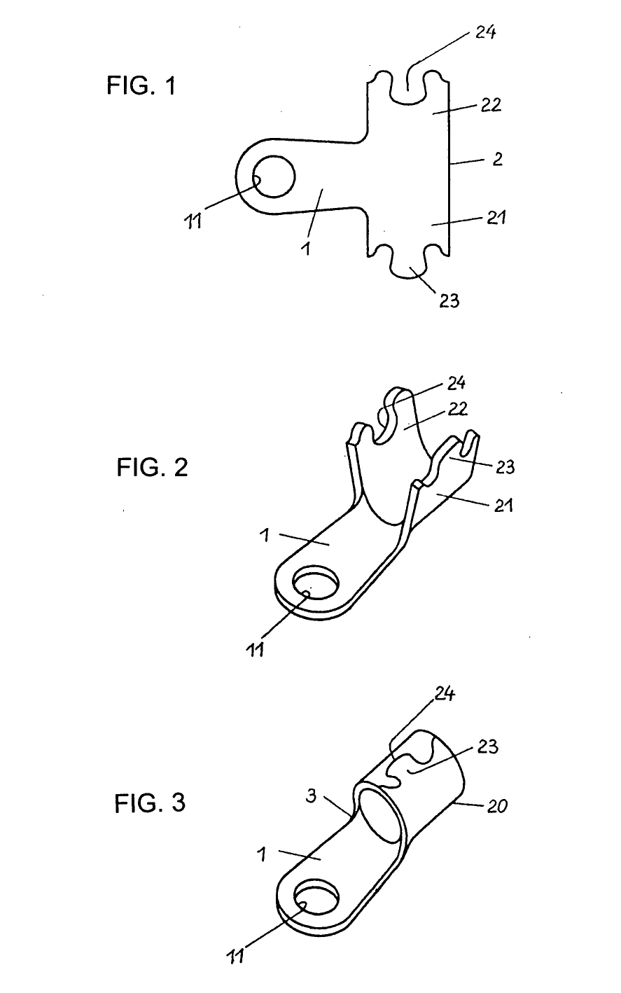

Referring now to the figures of the drawing in detail and first, particularly, to FIG. 1 thereof, there is seen a platelet which is produced by stamping and from which a connection element according to the invention is produced. This platelet comprises a first connection part 1, which is formed with a connection eyelet 11, and a second connection part 2, which is aligned transversely with respect to the first connection part 1 and which has two parts 21 and 22. In this case, the two parts 21 are formed, at their free ends, with an undercut projection 23 and with an undercut cutout 24 which is formed diametrically opposite the projection 23.

While the first connection part 1 illustrated here is formed with an eyelet, a variety of other or additional connection variants are available, such as an open U-tab, a threaded eye, a threaded post or a compression post, etc. All of these variants are generically referred to as connector means.

The platelet is formed of a copper alloy and it is nickel-plated over its entire surface.

As can be seen from FIG. 2 and FIG. 3, the two parts 21 and 22 are subsequently deformed to form a sleeve 20. The sleeve 20 is closed by the undercut projection 23 being inserted into the undercut cutout 24 such that the adjoining end faces of the two parts 21 and 22 are latched with one another. This provides a connecting terminal 3 according to the invention.

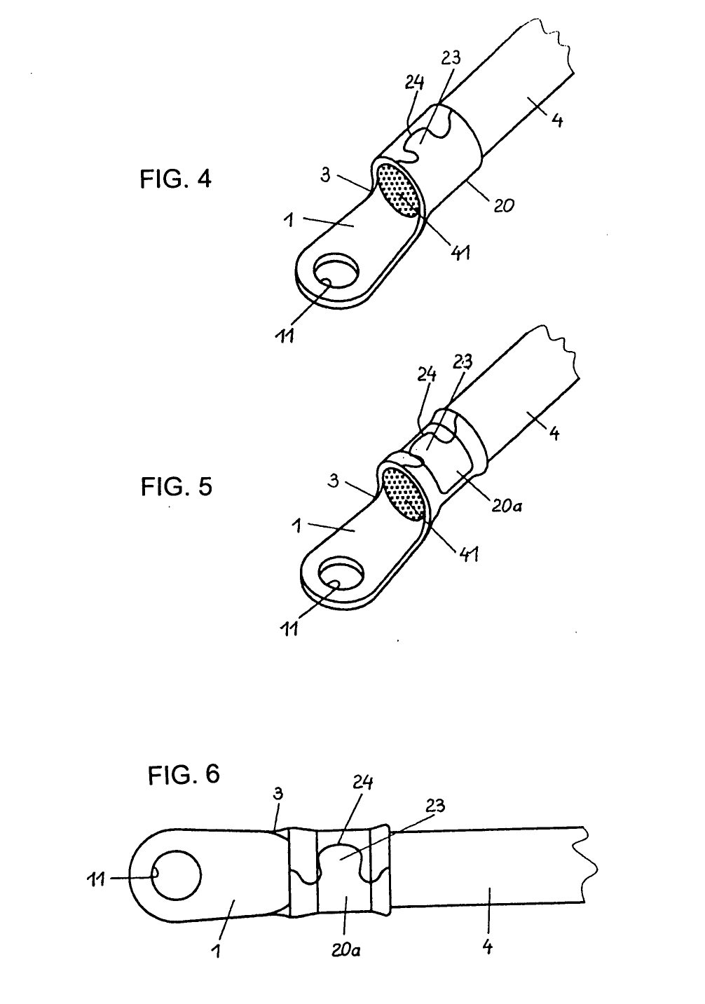

As can be seen from FIG. 4 and FIG. 5, the connecting terminal 3 formed thereby is connected to an electrical line 4 or an electrical cable. The conductor 41 (from which the insulation has been stripped) of the electrical line 4 is inserted into the sleeve 20 and, thereupon, the sleeve 20 is crimped or pressed to form a sleeve 20a with a reduced circumference.

FIG. 6 illustrates a plan view of the connecting terminal 3 connected to the conductor 41 by means of pressing.

This provides a connecting terminal 3, with which it is ensured that, when the sleeve-shaped connection part 20 is connected to the electrical conductor 41, a loosening of the connection caused by thermal expansion is avoided, as a result of which an increase in the contact resistance of this connection is ruled out.

This application claims the priority, under 35 U.S.C. §119, of Austrian patent application A 1533/2005, filed Sep. 16, 2005; the prior application is herewith incorporated by reference in its entirety.

I claim:

1. A connecting terminal for connecting an electrical line to an electrical device, the terminal comprising:
a first connection part formed with connector means;
a second connection part connected to said first connection part and connected or connectible to the electrical line by crimping;
said second connection part being a platelet deformed into a sleeve, said sleeve having adjoining edges provided with equal and opposed projections and cutouts corresponding to said projections, with said projections and cutouts latching said adjoining edges with one another.

2. The connecting terminal according to claim 1, wherein mutually opposing edges of said sleeve are formed with at least one undercut projection and at least one undercut cutout associated with said projection, respectively, and said at least one projection is inserted into said at least one cutout.

3. The connecting terminal according to claim 1, wherein said platelet and said first connection part are produced from a nickel-plated plate consisting of copper or a copper alloy.

4. The connecting terminal according to claim 3, wherein said nickel-plated plate is formed of bronze.

5. A method of connecting an electrical line and a connecting terminal, the method which comprises:
providing a connecting terminal according to claim 1;
inserting an electrical conductor of the electrical line into the second connection part formed as the sleeve; and
pressing the sleeve onto the electrical conductor for connecting the connecting terminal to the electrical conductor.
